(19) United States
(12) Patent Application Publication
(10) Pub. No.: US 2013/0210961 A1
(43) Pub. Date: Aug. 15, 2013

(54) Epoxy Composition with Crystallization Inhibition

(71) Applicants: Marvin L. Dettloff, Lake Jackson, TX (US); Radhakrishnan Karunakaran, Lake Jackson, TX (US)

(72) Inventors: Marvin L. Dettloff, Lake Jackson, TX (US); Radhakrishnan Karunakaran, Lake Jackson, TX (US)

(21) Appl. No.: 13/816,529

(22) PCT Filed: Sep. 22, 2011
(86) PCT No.: PCT/US11/52808

§ 371 Date: Apr. 17, 2013

Related U.S. Application Data
(60) Provisional application No. 61/387,308, filed on Sep. 28, 2010.

(51) Int. Cl. C08L 63/00; C09J 163/00; C09D 163/00

(52) U.S. Cl. CPC C08L 63/00; C09D 163/00; C09J 163/00
USPC 523/400; 525/523

(57) ABSTRACT

An epoxy resin composition formed, at least in part, as the reaction product of a mixture comprising 95 and 99 wt % of an epoxy component comprising one or more diglycidyl ethers of Bisphenol A and between 1 and 5 wt % of an additive component comprising one or more aromatic amines, wherein each aromatic amine contains no more than two amine hydrogen atoms is provided. Also provided is a method of using the epoxy resin composition including incorporating the epoxy resin composition into a coating, an adhesive, a sealant, a casting, a laminate, or a composite.

### FIELD OF THE INVENTION

The invention relates to an epoxy resin composition with improved crystallization resistance.

### BACKGROUND OF THE INVENTION

Standard epoxy resins based on Bisphenol A are often blended with 10 to 50 wt % of the diglycidyl ether of Bisphenol F (DGEBF) to reduce the tendency of such Bisphenol A-based resins to crystallize during storage and to moderate the viscosity of Bisphenol A-based resins. DGEBF offers several advantages over other known crystallization inhibiting resins, such as o-cresol glycidyl ether (CGE) or p-tert-butylphenyl glycidyl ether. For example, DGEBF does not adversely affect the mechanical properties of cured thermosets, has similar chemical reactivity as liquid Bisphenol A epoxy resins (DGEBA), has a well established track record as a crystallization inhibitor for liquid DGEBA epoxy resins, and greatly reduces the viscosity of liquid DGEBA epoxy resins.

In some applications, DGEBF has been reported to perform better than DGEBA resins. For example, DGEBF permits the use of increased filler amounts in casting formulations which leads to increased crack resistance and lower cost. Additionally, high resistance to cathodic disbondment is observed in powder coating applications using DGEBF-based formulations. While DGEBF offers a good range of performance attributes when combined with DGEBA, there are times when supplies of DGEBF are variable and on some occasions, DGEBF shortages occur. Such unpredictability and unreliability of DGEBF supply may result in additional manufacturing costs for those products utilizing such resins.

Therefore, alternatives to DGEBF are continually being sought for use with Bisphenol A-based epoxy resin composition to provide improved crystallization resistance while maintaining or improving other performance attributes at an affordable price.

### SUMMARY OF THE INVENTION

A first embodiment of the invention provides an epoxy resin composition comprising the reaction product of a mixture comprising between 95 and 99 wt % of an epoxy component comprising one or more diglycidyl ethers of Bisphenol A and between 1 and 5 wt % of an additive component comprising one or more aromatic amines, wherein each aromatic amine contains no more than two amine hydrogen atoms.

Another embodiment of the invention provides a method of using the inventive epoxy resin composition comprising incorporating the epoxy resin composition into a coating, an adhesive, a sealant, a casting, a laminate, or a composite.

In an alternative embodiment, the instant invention provides a epoxy resin composition and a method of using the same, in accordance with any of the preceding embodiments, except that

the aromatic amine is selected from aniline, ortho-toluidine, meta-toluidine, para-toluidine, 4-propylaniline, 4-ethylaniline, 3-chloroaniline, 4-hydroxyaniline, 3-cyanoaniline, 2,4-dimethylaniline, 2,6-dimethylaniline, N,N′-dimethylbenzene-1,4-diamine,1-naphthalenamine, and combinations and mixtures thereof In specific embodiments, the aromatic amine is aniline.

In an alternative embodiment, the instant invention provides a epoxy resin composition and a method of using the same, in accordance with any of the preceding embodiments, except that the mixture comprises between 1.3 and 2.5 wt % aromatic amine and 98.7 and 97.5 wt % diglycidyl ether of Bisphenol A. In alternative embodiments, the mixture comprises 97.5 wt % diglycidyl ether of Bisphenol A and 2.5 wt % of aniline.

In an alternative embodiment, the instant invention provides a epoxy resin composition and a method of using the same, in accordance with any of the preceding embodiments, except that the diglycidyl ether of Bisphenol A has an epoxide equivalent weight between 172 and 176 g/equivalent and a viscosity of between 4,000 and 6,000 cP at 25° C. In alternative embodiments, the diglycidyl ether of Bisphenol A has an epoxide equivalent weight between 182 and 192 g/equivalent and a viscosity of between 11,000 and 14,000 cP at 25° C. In yet other embodiments, the diglycidyl ether of Bisphenol A has an epoxide equivalent weight between 176 and 183 g/equivalent and a viscosity of between 9,000 and 10,500 cP at 25° C.

In an alternative embodiment, the instant invention provides a epoxy resin composition and a method of using the same, in accordance with any of the preceding embodiments, except that the epoxy resin composition exhibit improved crystallization inhibition over unmodified diglycidyl ether of Bisphenol A.

Another embodiment of the invention provides an epoxy resin composition consisting essentially of the reaction product of a mixture comprising between 95 and 99 wt % diglycidyl ether of Bisphenol A and between 1 and 5 wt % of aromatic amine containing no more than two amine hydrogen atoms.

### DETAILED DESCRIPTION OF EMBODIMENTS OF THE INVENTION

One aspect of the invention provides an epoxy resin composition comprising the reaction product of a mixture comprising between 85 and 99 wt % of an epoxy component comprising one or more diglycidyl ethers of Bisphenol A with between 1 and 15 weight percent of an additive component comprising one or more aromatic amine containing no more than two amine hydrogen atoms. All individual values and sub-ranges from 1 to 15 percent by weight are included herein and disclosed herein; for example, the weight percent of the aromatic amine may be from a lower limit of 1, 3, 5, 7, 10, or 12 weight percent to an upper limit of 4, 6, 8, 10, 12, or 15 weight percent, based on the total weight of the DGEBA epoxy composition. For example, the weight percent of the aromatic amine may be in the range of from 1 to 15 weight percent, or in the alternative, from 5 to 10 weight percent, or in the alternative, from 7 to 15 weight percent, based on the total weight of the DGEBA epoxy composition.

In some embodiments of the epoxy resin composition, the mixture comprises between 1.3 and 2.5 wt % aromatic amine and 98.7 and 97.5 wt % diglycidyl ether of Bisphenol A. All individual values and sub-ranges from 1.3 to 2.5 percent by weight are included herein and disclosed herein; for example, the weight percent of the aromatic amine may be from a lower limit of 1.3, 1.5, 1.7, 1.9, 2.1, or 2.3 weight percent to an upper limit of 1.5, 1.7, 1.9, 2.1, 2.3 or 2.5 weight percent, based on the total weight of the DGEBA epoxy composition. For example, the weight percent of the aromatic amine may be in the range of from 1.3 to 2.5 weight percent, or in the alternative, from 1.5 to 2.0 weight percent, or in the alternative, from 1.7 to 2.1 weight percent, based on the total weight of the DGEBA epoxy composition.

In a preferred embodiment the epoxy resin composition comprises the reaction product of a mixture which comprises 97.5 wt % diglycidyl ether of Bisphenol A and 2.5 wt % of aniline.

The aromatic amine may contain one amine hydrogen atoms or two amine hydrogen atoms.

In some embodiments of the invention the aromatic amine may comprise one or more aromatic amines, wherein each aromatic amine has no more than 2 amine hydrogen atoms.

Another aspect of the invention provides such an amine-modified DGEBA epoxy composition which exhibits improved crystallization resistance over DGEBA epoxy.

In certain aspects of the invention, aromatic amines useful in producing the inventive amine-modified DGEBA epoxy compositions include, by way of example, aniline, ortho-toluidine, meta-toluidine, para-toluidine, 4-propylaniline, 4-ethylaniline, 3-chloroaniline, 4-hydroxyaniline, 3-cyanoaniline, 2,4-dimethylaniline, 2,6-dimethylaniline, N,N′-dimethylbenzene-1,4-diamine, 1-naphthalenamine, N-methylaniline, N-ethylaniline, N-methyl-p-toluidine, N-methyl-o-toluidine, N-methyl-m-toluidine, N-methyl-p-propylamine and mixtures thereof.

Liquid epoxy resins suitable for use in the invention include those derived from the reaction product of Bisphenol A with epichlorohydrin. Commercially available examples of such useful liquid epoxy resins include those available from: (1) the Dow Chemical Company, and sold as D.E.R.™ 330, D.E.R.™ 331, or D.E.R.™ 383; (2) Hexion Specialty Chemicals Company and sold as EPONTM 828; (3) Huntsman International LLC and sold as ARALDITE™ GY 6010; (4) Nan Ya Plastics Corp. (Taiwan) and sold as NPEL-128; and (5) Dalian Quiha (Peoples Republic of China) and sold as DYD-128. In various embodiments of the inventive epoxy composition, one or more liquid epoxy resins derived from the reaction product of Bisphenol A and epichlorohydrin may be used.

The inventive epoxy resin compositions exhibit improved crystallization inhibition over unmodified diglycidyl ether of Bisphenol A. As used herein, “improved crystallization inhibition over unmodified diglycidyl ether of Bisphenol A” means that that the inventive resin composition will remain in Stages A & B combined for at least 30% greater time period before entering Stage C, as measured by ISO method 4895, than the unmodified diglycidyl ether of Bisphenol A. In some embodiments, the inventive epoxy resins remain in Stages A and/or B for at least 10 days, or in the alternative, for at least 20 days, in the alternative, for at least 30 days, or in the alternative, for at least 40 days, or in the alternative, for at least 60 days.

In some embodiments of the invention, the inventive epoxy compositions may be used in one or more applications, including, by way of example, coatings, adhesives, sealants, castings, laminates and composites.

### Test Methods

### Crystallization Resistance Study

ISO method 4895 was used to evaluate the crystallization resistance of resin blends. The calcium carbonate was conditioned in an oven for 3 h at 125° C., and then equilibrated at room temperature. DGEBF and DGEBA samples were heated in an oven for 16 h at 60° C. to melt any crystals and equilibrated at room temperature for 1 h. Each tested epoxy resin (20 g), conditioned calcium carbonate (20g), and ethanol (2g) were added to a 4-oz glass bottle and manually mixed for 2 minutes using a glass stirring rod.

The bottle containing the mixed ingredients was sealed with a plastic screw cap then placed in the vertical position in a refrigerator at 10° C. The following morning the sample was removed from the refrigerator and equilibrated at approximately 22° C. for about 1 h. The bottle was then placed in the horizontal position for 1 minute. The sample was observed and the flow ranked as follows:

Stage A: sample flowed and reached the bottle neck within a minute.

Stage B: sample flowed and did not reach the bottle neck.

Stage C: no observable sample flow.

After recording the initial stage of the sample flow, the sample was manually mixed for one minute using a glass rod and returned to the refrigerator. The samples were processed daily in this manner. The samples were discarded when their flow reached Stage C or after 60 days of testing. The tendency of a sample to crystallize was expressed as the time the sample was in Stages A and B. Thus, the longer the time a sample remains in Stage A and B, the less tendency that sample has to crystallize.

### Inventive and Comparative Examples

The following examples illustrate the present invention but are not intended to limit the scope of the invention.

Table 1 describes the base epoxy resins used in the comparative and inventive examples.

TABLE 1

| | | | Epoxide | |
|---|---|---|---|---|
| | | | equivalent weight | Viscosity |
| Material | Tradename | Available from | (g/equivalent) | (cP @ 25° C.) |
| Diglycidyl ether of | D.E.R. ™ | The Dow Chemical | 172-176 | 4,000-6,000 |
| Bisphenol A | 332 | Company | | |
| Diglycidyl ether of | D.E.R. ™ | The Dow Chemical | 182-192 | 11,000-14,000 |
| Bisphenol A | 331 | Company | | |
| Diglycidyl ether of | D.E.R. ™ | The Dow Chemical | 176-183 | 9,000-10,500 |
| Bisphenol A | 383 | Company | | |
| Diglycidyl ether of | D.E.R. ™ | The Dow Chemical | 158-175 | 3,000-3,000 |
| Bisphenol F | 354 | Company | | |

Other chemicals used included the following:

VICRON™ 41-8 food grade limestone (i.e., calcium carbonate) (available from Specialty Materials, Adams, Mass.); and ethanol obtained from Sigma-Aldrich Co.

To prepare the inventive examples, a diglycidyl ether of Bisphenol A, as described in Table 1, was added to a 4 oz glass bottle followed by the dropwise addition of aniline to give the targeted weight percent of aniline in the mixture. The mixture was heated to 60° C. and shaken well to achieve a homogeneous mixture. The bottle was then placed in an oven at 80° C. for 3 hours with occasional stirring. After 3 hours the mixture was cooled to room temperature and tested for crystallization inhibition. The comparative examples were preconditioned by heating in an oven for 16 hours at 60° C. to melt any crystal present and then equilibrated at room temperature for one hour prior to crystallization inhibition testing. Table 2 below shows the composition of each inventive and comparative example as well as the results of the crystallization inhibition testing according to ISO method 4895.

TABLE 2

| | Number of | Number of Days |
|---|---|---|
| | Days in | in |
| Composition | Stage A | Stage B |
| Compositions based on D.E.R. ™ 332 | | |
| Comparative Example 1 | 0 | 1 |
| (D.E.R. ™ 332) | | |
| Comparative Example 2 | 5 | 10 |
| (D.E.R. ™ 332 + 14 wt % D.E.R. ™ 354) | | |
| Inventive Example 1 | 2 | 1 |
| (D.E.R. ™ 332 + 1.3 wt % aniline) | | |
| Inventive Example 2 | 3 | 1 |
| (D.E.R. ™ 332 + 2.5 wt % aniline) | | |
| Compositions based on D.E.R. ™ 383 | | |
| Comparative Example 3 (D.E.R. ™ 383) | 4 | 6 |
| Comparative Example 4 | 60 | * |
| (D.E.R. ™ 383 + 14 wt % D.E.R. ™ 354) | | |
| Inventive Example 3 | 5 | 10 |
| (D.E.R. ™ 383 + 1.3 wt % aniline) | | |
| Inventive Example 4 | 60 | * |
| (D.E.R. ™ 383 + 2.5 wt % aniline) | | |
| Compositions based on D.E.R. ™ 331 | | |
| Comparative Example 5 (D.E.R. ™ 331) | 7 | 2 |
| Comparative Example 6 | 32 | 4 |
| (D.E.R. ™ 331 + 14 wt % D.E.R. ™ 354) | | |
| Inventive Example 5 | 23 | 15 |
| (D.E.R. ™ 331 + 1.3 wt % aniline) | | |
| Inventive Example 6 | 60 | * |
| (D.E.R. ™ 331 + 2.5 wt % aniline) | | |

*Remained in Stage A at the end of 60 days, at which time the test was terminated.

The comparative examples show the crystallization tendency of the Bisphenol A diglycidyl ether epoxy resins with no additive as well as with 14 weight percent D.E.R.™354 (DGEBF). As can be seen, D.E.R.™332 (Comparative Example 1) shows rapid entry into Stages B and C. That is, D.E.R.™332 rapidly exhibits crystallization when not modified by the presence of DGEBF or aniline. The aromatic amine modification of D.E.R.™ 332 improves crystallization resistance compared to the D.E.R.™ 332 resin without modification.

The aromatic amine modification significantly improves the crystallization resistance of the unmodified D.E.R.™ 383 and D.E.R.™ 331. At a 2.5 wt % aniline level modification, D.E.R.™ 383 and D.E.R.™ 331 resins remained in Stage B through the sixtieth day of crystallization testing.

The present invention may be embodied in other forms without departing from the spirit and the essential attributes thereof, and, accordingly, reference should be made to the appended claims, rather than to the foregoing specification, as indicating the scope of the invention.

We claim:

1. An epoxy resin composition comprising the reaction product of a mixture comprising between 95 and 99 wt % of an epoxy component comprising one or more diglycidyl ethers of Bisphenol A and between 1 and 5 wt % of an additive component comprising one or more aromatic amines, wherein each aromatic amine contains no more than two amine hydrogen atoms.

2. The epoxy resin composition of claim 1 wherein the one or more aromatic amines are selected from aniline, ortho-toluidine, meta-toluidine, para-toluidine, 4-propylaniline, 4-ethylaniline, 3-chloroaniline, 4-hydroxyaniline, 3-cyanoaniline, 2,4-dimethylaniline, 2,6-dimethylaniline, N,N′-dimethylbenzene-1,4-diamine,1-naphthalenamine, and combinations and mixtures thereof

3. The epoxy resin composition according to claim 1 wherein the one or more aromatic amines comprises aniline.

4. The epoxy resin composition of claim 1 wherein the mixture comprises between 98.7 and 97.5 wt % of one or more diglycidyl ethers of Bisphenol A and between 1.3 and 2.5 wt % aromatic amine.

5. The epoxy resin composition of claim 4 wherein the mixture comprises 97.5 wt % of one or more diglycidyl ethers of Bisphenol A and 2.5 wt % of aniline.

6. The epoxy resin composition according to claim 1 wherein the one or more diglycidyl ethers of Bisphenol A have an epoxide equivalent weight between 172 and 176 g/equivalent and a viscosity between 4,000 and 6,000 cP at 25° C.

7. The epoxy resin composition according to claim 1 wherein the one or more diglycidyl ethers of Bisphenol A have an epoxide equivalent weight between 182 and 192 g/equivalent and a viscosity between 11,000 and 14,000 cP at 25° C.

8. The epoxy resin composition according to claim 1 wherein the one or more diglycidyl ethers of Bisphenol A have an epoxide equivalent weight between 176 and 183 g/equivalent and a viscosity of between 9,000 and 10,500 cP at 25° C.

9. The epoxy resin composition according to claim 1 wherein the epoxy resin composition exhibits improved crystallization inhibition over the one or more diglycidyl ethers of Bisphenol A.

10. A method of using the epoxy resin composition according to claim 1 comprising incorporating the epoxy resin composition into a coating, an adhesive, a sealant, a casting, a laminate, or a composite.
